(19) United States
(12) Patent Application Publication
(10) Pub. No.: US 2012/0287620 A1
(43) Pub. Date: Nov. 15, 2012

(54) LED Lighting

(76) Inventor: Salvatore Guerrieri, Jersey City, NJ (US)

(21) Appl. No.: 13/104,350

(22) Filed: May 10, 2011

(51) Int. Cl. F21V 9/00

(52) U.S. Cl. 362/231

(57) ABSTRACT

An LED lighting device is described that has a strip of LEDS located on a housing. The LEDs will be in groups such that the light from the plurality of LEDs will be evenly blended in with the light from the other LEDs in the group. The light will be blended evenly on a plastic lens cap located above the group of LEDs. A diffusion gel and/or holographic paper can also add to the even spread of the LED light. The LEDs contained in the group will basically be a warm white LED, a cool white LED and a colored LED. The colored LED can be an amber or red LED.

### BACKGROUND OF THE INVENTION

1. Field of the Invention

This invention relates to an apparatus for providing LED based light that accurately mimics traditional lighting sources such as halogen, incandescent and fluorescent lights.

2. Description of the Related Art

Light emitting diodes (“LED”) have become a relatively inexpensive alternative to traditional lighting sources. LEDs have lower energy consumption, longer lifetime, improved robustness, smaller size, faster switching, and greater durability and reliability than other traditional light sources. LEDs can be made to emit light in all of the visible light spectrum except white depending on the composition of the dye used in the semiconductor material.

In order to simulate white lights, LED manufacturers will typically use one of two methods. The first method utilizes three separate LEDs—red, green and blue (RGB). Mixing the color output from these three LEDs allows the color white to be produced. However, this method can have some disadvantages as the color mixing of three separate LEDs is not a simple process to guarantee a blended and evenly mixed white light color. Having an blended and evenly mixed color through color mixing is important. Having a white light that has green tinges in the areas closer to the green LED and/or red tinges in the areas closer to the red LED would not be aesthetically pleasing.

Another problem with the RGB solution is that it is hard to account for the variations that occur as between individual LEDs. While the color of the LED can be fairly characterized as being red, green or blue, variations as between the different shades of red, green and blue can be great. One green LED can have a very different look that another green LED. This variation can occur as between different manufacturers of each LED and even occur as between different batches of LEDs that are manufactured by the same manufacturer. This variation makes it difficult to produce a standard “white” as the same mixture of light from the RGB LEDs will produce different white lights and generally this produces a bluer white and not a warm white light.

The second method is to utilize a single blue LED with a phosphor coating to mix yellow light with blue to produce light that appears white. This method is simpler and cheaper than a complex RGB system as it involves only one LED opposed to three separate LEDs that will each have different variations as between themselves. The manufacturer of a single blue LED with a phosphor coating will be able to better adjust the light emission to produce an evenly mixed and blended white color. However, since a single LED is being used, the variations as between whites produced is even more pronounced than the RGB solution and also shows a yellow color on the face of the LED when not lit, which is not acceptable from the industry. Without the ability to alter the different mixture of RGB LEDs, the single blue LED will always be the same white and cannot be adjusted easily to match another phosphor coated or remote phosphor blue LED.

In producing white light with LEDs, it can be desirable to produce white light that will mimic traditional lighting sources. For example, traditional lighting fixtures that are used in the typical home are usually incandescent lights and halogens. It might be desirable to use LEDs in place of an incandescent light bulb to gain the above mentioned benefits of using LEDs yet to retain the lighting effect of an incandescent bulb.

Color temperature is a characteristic of visible light that has been used to describe the different colors produced in LEDs. Color temperature is conventionally stated in the unit of absolute temperature, the Kelvin, having the unit symbol K. Color temperatures over 5,000K are called cool colors (bluish white), while lower color temperatures (2,250-3,000 K) are called warm colors (yellowish white through red). For the various white colors, the temperature color can be used to describe the type of white light emitted. For example, a 2500 Kelvin white could be considered to be an approximation of an incandescent bulb while a 3400 Kelvin white could be considered to be the approximation of a halogen light.

It would be desirable to have an LED lighting fixture that emits white light and can mimic the lighting effect of traditional lighting sources. In addition, it would be desirable to have an LED lighting fixture that can produce a standard white light despite the variations that occur between specific LEDs.

### SUMMARY OF THE INVENTION

The above objects of the invention and advantages are achieved by having a lighting fixture that would be able to be adjusted to mimic the various looks of traditional light sources. The lighting fixture would be composed of a combination of LEDs that are composed of a warm white LED, cool white LED and an amber LED and/or red LED. The ratio as between the white LEDs to the colored LED would ideally be a 2:1 ratio. The placement of the LEDs on the lighting strip would ideally have the colored LED surrounded by the white LEDs. By using two different color temperatures of white along with an amber LED or red LED, the whole spectrum of different types of whites can be produced. Additionally, the blending and even mixing of the different lights would be easier than the white produced from the RGB LED lighting solution since two of the sources are white to begin with.

Another aspect of the present invention would be to normalize the different color combinations to produce a standard white color as between the different variations that can occur for each bin of LEDs produced for each manufacturer.

Another aspect of the present invention would be to have a controller that will be able to adjust the different brightness levels of the LEDs in the lighting fixture to blend in with the color temperatures of the light already present.

### BRIEF DESCRIPTION OF THE DRAWINGS

FIG. 1 is a view of the components of the invented system according to one embodiment of the present invention.

FIG. 2 is a top view of the LED housing according to one embodiment of the present invention.

FIG. 3 is a top view of another configuration of the LED housing according to one embodiment of the present invention.

FIG. 4 is a top view of another configuration of the LED housing according to one embodiment of the present invention.

FIG. 5 is a top view of another configuration of the LED housing according to one embodiment of the present invention.

FIGS. 6(a) and (b) are a side and perspective view of the LED housing according to one embodiment of the present invention.

FIG. 7 is a top view of the LED housing according to another embodiment of the present invention.

FIG. 8 is a top view of the LED housing according to another embodiment of the present invention.

FIG. 9 is a view of a remote control used in the present invention.

FIG. 10 is a flow chart depicting the process of normalizing the settings of the LEDs in accordance with one aspect of the present invention.

### DETAILED DESCRIPTION OF THE EMBODIMENTS

For the purposes of understanding the invention, reference will now be made to the embodiments illustrated in the drawings. It will be understood that no limitation of the scope of the invention is thereby intended. Any alterations and further modifications in the described embodiments, and any further applications of the principles of the invention as described herein are contemplated as would normally occur to one skilled in the art to which the invention relates.

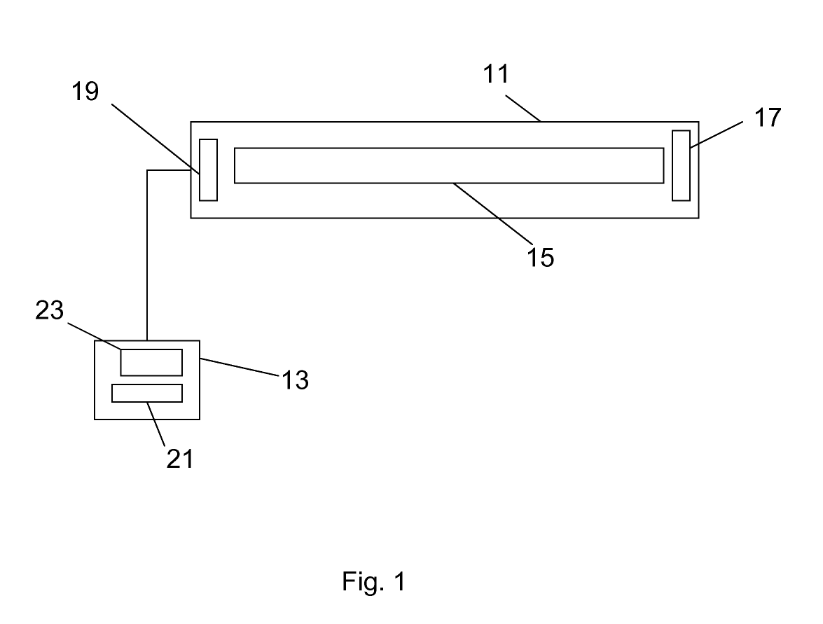

FIG. 1 depicts the components of the present invention in accordance with one embodiment of the invention. LED lighting device is composed of LED housing 11 connected to controller 13. LED housing 11 is shown as a long strip that houses LED lighting strip 15, light meter 17 and control circuitry 19. Controller 13 has processor 21 and memory 23. LED lighting strip 15, light meter 17 and control circuitry 19 are electrically connected to each other and controller 13. The shape of LED housing 11 can take any form and still be in the scope of the invention.

Light meter 17 can receive incident light and determine the color temperature of the light. Light meter 17 will be able to communicate that information back to controller 13. Control circuitry 19 is capable of changing the brightness of the light emitted for each LED contained in the LED lighting strip. Processor 13 runs software that controls control circuitry 19 and will be able to store settings in memory 23.

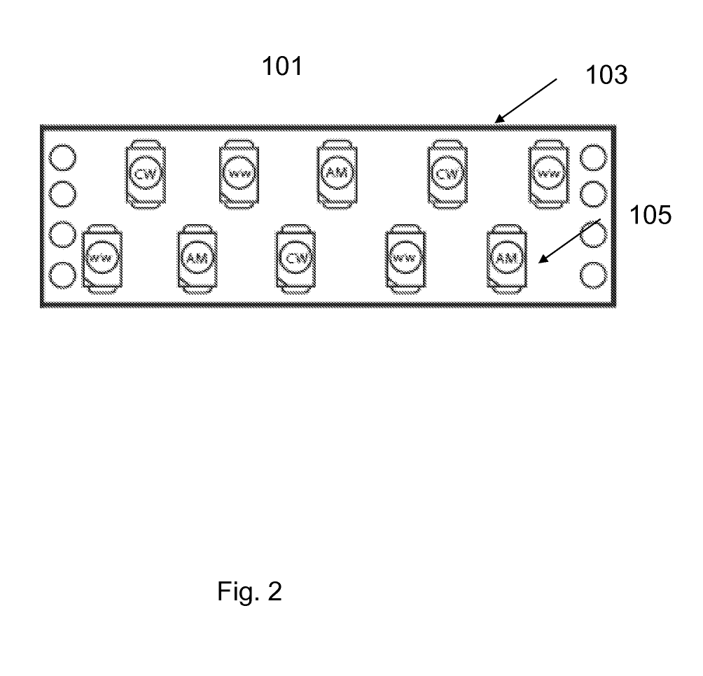

FIG. 2 depicts a top view of one embodiment of the LED lighting strip in accordance with one embodiment of the present invention. LED lighting strip 101 is composed of a housing 103 with the LEDs 105 placed on the top of the housing. The housing is made of a PCB and is approximately ½ inch in width, but the material, shape and dimensions can be changed and still be in the scope of the invention.

The LEDs are of three types: warm white, cool white and amber. The LEDs are located in two staggered double rows of alternating colors. The staggering of the LEDs allows for the warm white, cool white and amber to be spaced evenly from each other to ensure that the colors will be evenly mixed. As can be seen in FIG. 2, the amber LED is always surrounded by either a cool white or a warm white thereby making the ratio of white LEDs to colored LEDs a 2:1 ratio. This ratio allows for the best mixing of LED lights to achieve the various white lighting effects. The distance between the LEDs is made as close as possible to better aid in the even mixing of the different LED lights.

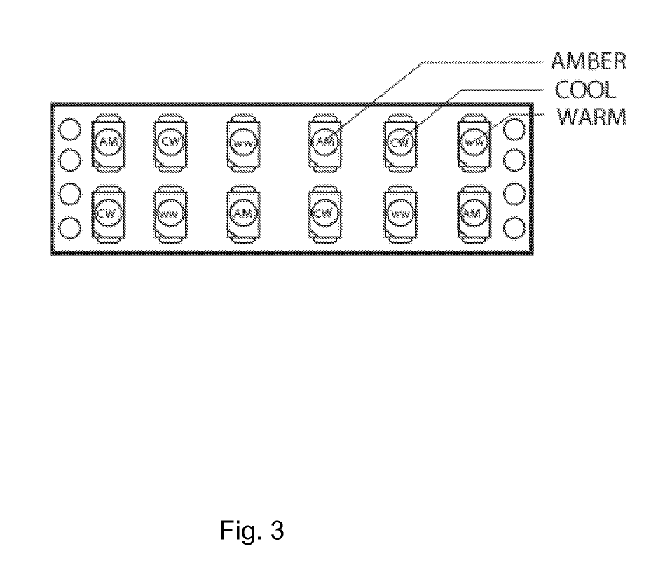

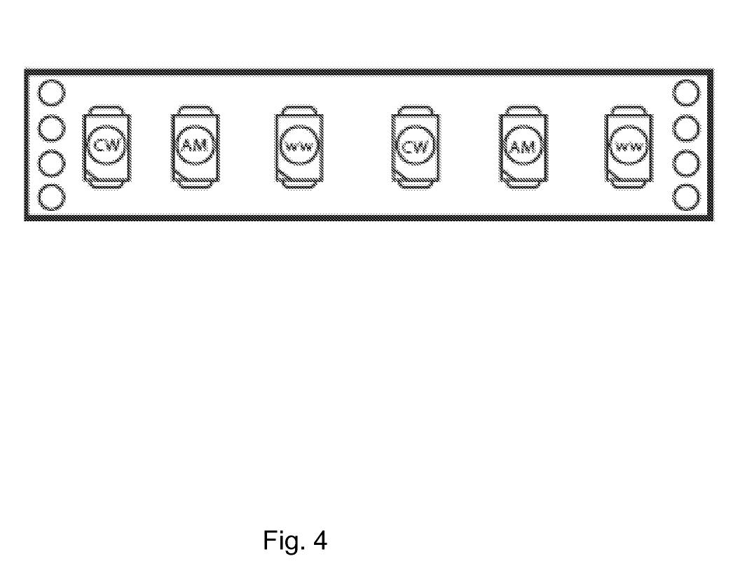

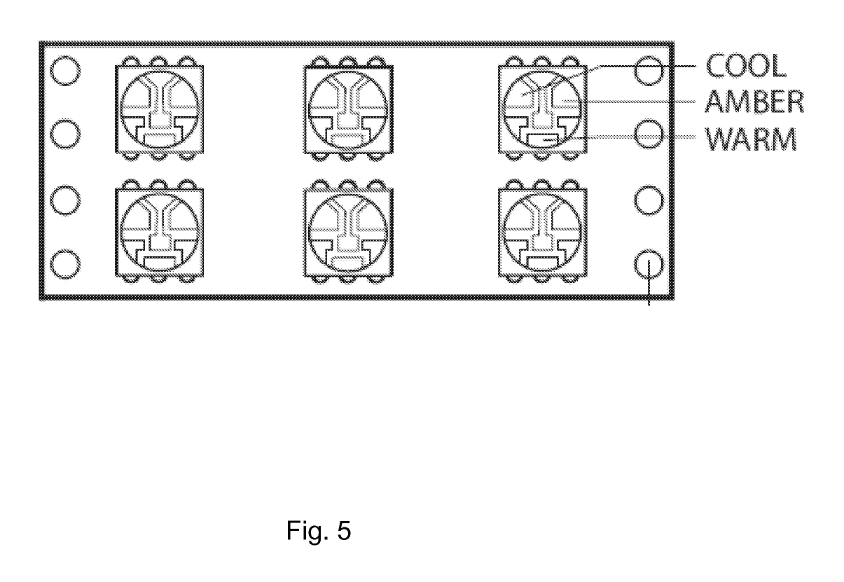

FIGS. 3-5 depict alternative configurations of the first embodiment wherein the locations of the LEDs are changed. FIG. 3 shows, the LEDs are in a double row that is not staggered. In this configuration, the amber color is still surrounded by the warm white and cool white LEDs. In fact, this configuration shows that the amber LED is immediately surrounded on three sides by the white LEDs. FIG. 4 shows a single row of alternating warm white, cool white and amber LED lights. This configuration still has the amber LED surrounded by two white LEDs. By using a single row of LEDs, this design allows for an even thinner strip to be produced. FIG. 5 shows a double row of tri-color LEDs. While each LED is shown as a single LED, the LED is actually made of three separate LEDs and the location of the different LEDs are in a triangular configuration similar to the configuration of FIG. 1. These devices maximize the blending of the colors by minimizing the spacing as between the different LEDs.

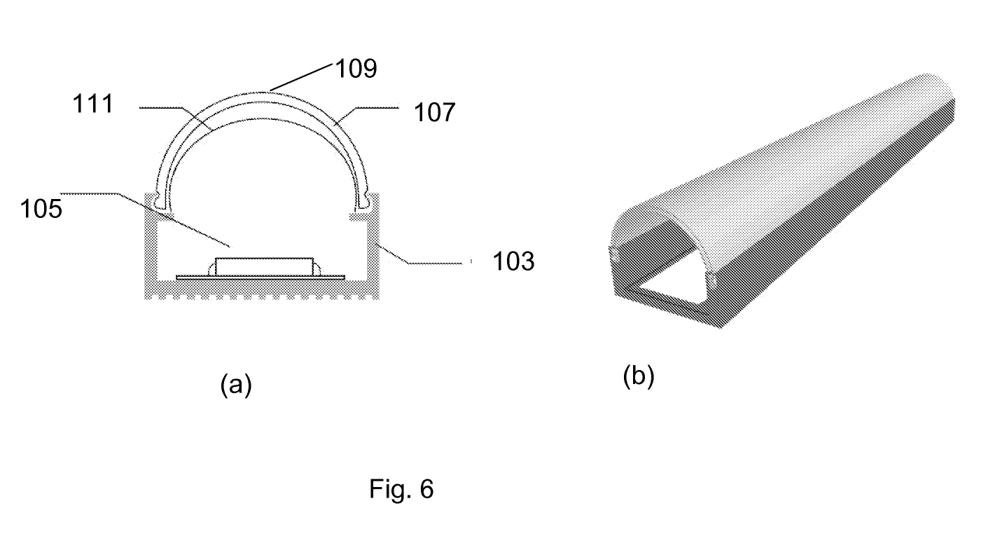

FIGS. 6(a) and (b) depict a side view and perspective view of the first embodiment. As shown, housing 103 has LEDs 105 embedded on the top. Above the LEDs a clear plastic lens 107 is located. This clear plastic lens 107 will extend the entire length of the housing 103 and will aid in mixing and blending the colors. The position of the LEDs on the strip and the distance of the lens from these LEDs are chosen to ensure that the lights incident on the lens are evenly blended. The color of the light incident on the lens will be the light that is visible to the viewer.

In addition to the clear plastic lens cap, a diffusion 109 gel is located under the plastic cap. This diffusion gel is composed of any suitable material that will help to diffuse the light incident on the cap. This allows for the light to spread even more along the clear plastic lens cap and will smooth out the color mixing. A layer of holographic paper 111 can also be added to the plastic lens cap layer. The holographic paper will also diffract the light incident on it allowing the light to spread even more along the clear plastic lens 107. Additional materials and/or layers can be added that will also aid in creating an even mix of colors on the lens as long as the effect of any of those layers is to increase the spread of the colors along the clear plastic lens.

The effect of this configuration allows the lighting fixture to be able to accurately produce all types of white lighting that could be desired and still minimize the space needed. However, by using two white LEDs in combination with an amber colored LED, the color mixing is better than an RGB system because two of the LEDs are already a white color. The difficulties of mixing different colors, as in the RGB system, is avoided.

It is found that the amber LED will allow for the lighting mixture to better approximate traditional lighting sources. For example, a halogen light traditionally has an orange tinge to its color. In comparison, a typical phosphor coated white LED does not have an orange tinge. By having the amber LED mixed in with the two white colors, the invented lighting fixture will be capable of more accurately blending the color mixtures to simulate a halogen light. This system also improves on other systems that simply rely on having the different color temperature whites by allowing the infusion of a color directly into the mix.

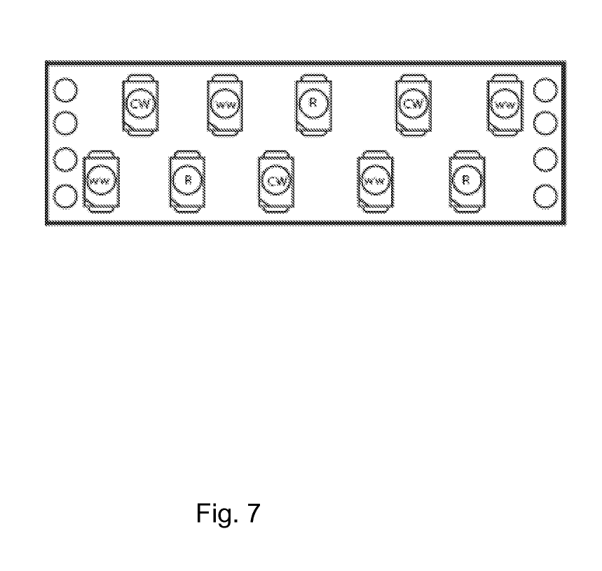

FIG. 7 shows a second embodiment of the present invention wherein a red LED is used instead of an amber LED. In this figure, the staggered double row configuration of FIG. 2 is depicted with the red LED swapped out for the amber LED, but any of the other configurations can be used. The use of a red LED also allows for the better simulation of traditional lighting sources. In particular, an incandescent lighting has a tinge of red color and the use of a red LED allows for the direct manipulation of the color mixing to better approximate that lighting source.

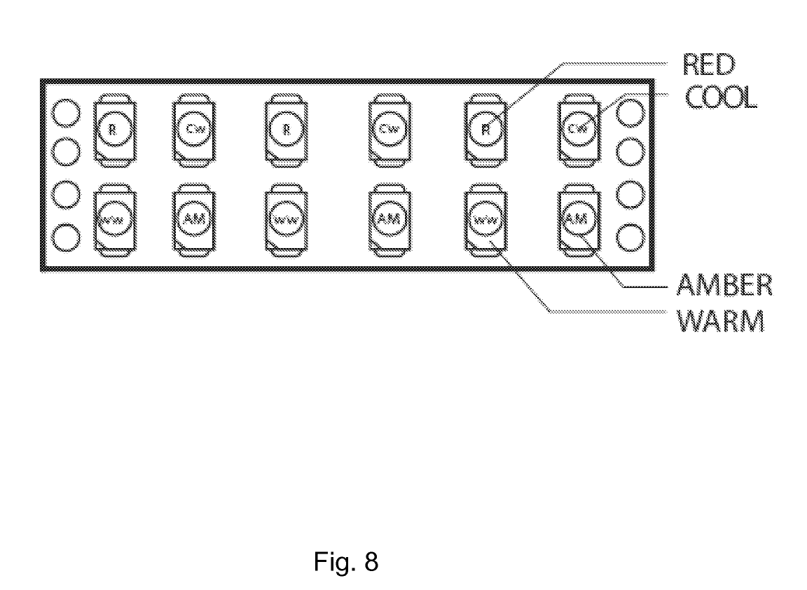

FIG. 8 shows a third embodiment wherein both a red and amber LED is used in conjunction with the two white LEDs. The configuration is a double row of LEDs with each colored LED surrounded by white LEDs. By having this combination, it is found that the red and yellow components that typically needed to be added to a phosphor coated white LED are there and virtually all of the different white lighting effects can be achieved.

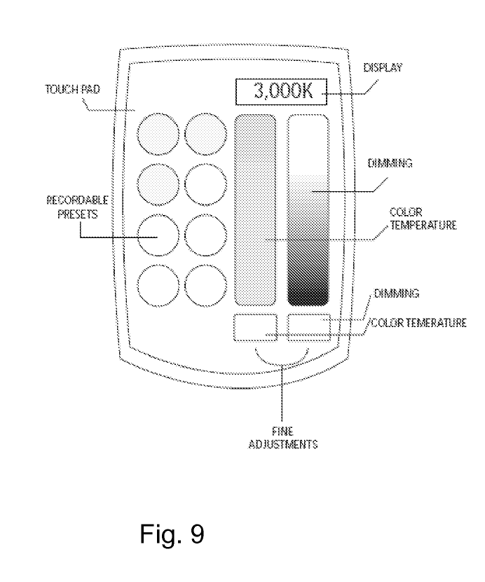

The invented lighting device can operate in various modes. FIG. 9 shows a remote controller that can be optionally implemented with such a system. This invented system is compatible with many of the different mixing systems that already exist out in the marketplace such as the DMX system 0-10 dimming system, standard triac dimming or the PWM system.

In the remote controller, the user will be able to see the Kelvin temperature color in a digital display. Two separate sliding bars allows the user to adjust the color temperature and the brightness of the lights. The display of the color temperature will change as the user is adjusting it. Once the desired lighting effect is achieved, the user can store the setting in memory and assign it to one of the memory buttons located on the remote control. The settings are stored in memory in the controller.

In addition to the sliding bars, the system will be pre-programmed with preset lighting mixtures that is programmed to mimic the lighting effect of traditional lighting sources. These preset lighting mixtures are represented by buttons on the remote control and the buttons can be labeled with icons showing the different traditional lighting sources. In order to have the lighting device mimic a traditional lighting source, the user would press the button that is already configured for that lighting and the controller will set the different LEDs in the lighting fixture to best approximate that color.

Another mode that the lighting fixture can operate in will allow the lighting fixture to blend in with the already existing light. Light meter 17 that is located on the lighting fixture will be able to sample the ambient light and determine the different color temperatures of that light. The light sampled can be from other lighting devices that are in the same room. It can also be a reflection of light from other light sources nearby as light can be reflected off the walls and ceilings of the room. Once the different color temperatures of the ambient light is communicated from the light meter to the controller in an active feedback loop according to the invented software, the controller can set a color temperature that will be best suited to blend in with the ambient light. Typically, it would be a color temperature that is the average of the color temperatures of the ambient light, but it can vary depending on the circumstances. The user can set the controller/software to match the color tempiature in between other light sources in the room or even to a complimentary color temp as the user see fit.

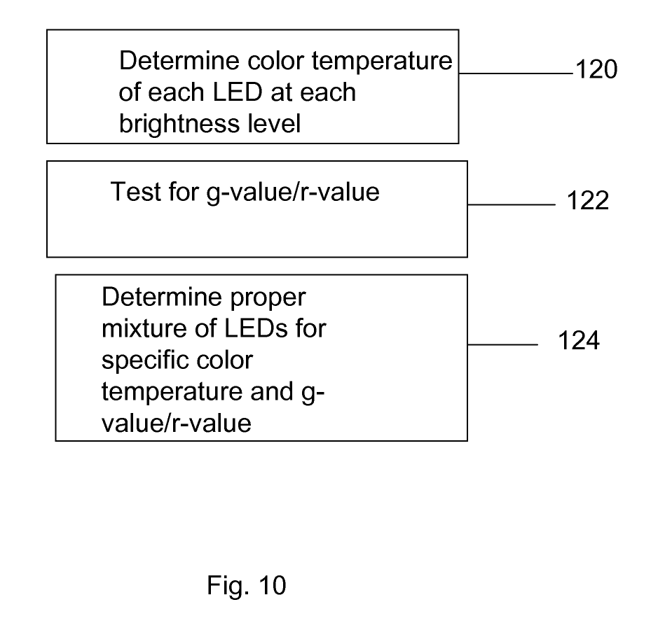

In order to mix the light from the LEDs to accurately approximate all different white lighting effects, the invented lighting device will normalize the LEDs. This process is depicted in FIG. 10. The first step 120 in the process is to determine the Kelvin temperature of the individual LEDs that will be placed in the housing. This is typically done with a light meter. The use of a light meter is important because it will give the actual measurement of the Kelvin color temperature. While manufacturers often will give the Kelvin color temperature of the LEDs that they produce, the variance that can occur between Kelvin degrees can be great particularly with more inexpensive LEDs. Measuring the actual Kelvin temperature allows for the use of cheaper LEDs in the lighting fixture since it does not rely on the manufacturer's assessment of the color temperature and the problem of variance in color temperatures among the LEDs can be accounted for.

The second step 122 is to test the actual color of the LED against color swatches to determine the exactly the color output of the LED. It is well known that variations among different sets of LEDs can vary greatly such that a manufacturer of LEDs can produce four different bins of the same colored LED that vary in shades of color. One white LED can have a greenish tinge while another has a reddish tinge. This makes it important for each LED from each bin to be tested to determine the nuances of color that it outputs. The color tinges are usually expressed as a g-value (GREEN) or an r-value (RED). This testing is performed at every brightness level because the g-values or r-values can be different at each brightness level.

Once the Kelvin color temperature and the g-value or r-value of the different LEDs are known, these values will be used to determine the proper mixture of brightness from each of the LEDs in the lighting fixture in order to simulate the traditional lighting sources by inputting the values of these measured characteristics into the invented software. The starting values of the Kelvin color temperature and the g-values or r-values for each of the LEDs in the group of LEDs will be entered into the controller. The controller will then be programmed to set the appropriate levels of brightness of the different LEDs in the lighting fixture for the desired color temperature and brightness level. The programming will take into account the starting values of the Kelvin color temperature and the g-values/r-values of the LEDs. In addition, the programming will also account for whether the third colored LED is a red, amber or a combination of both. The addition of the red or amber LED with the two white LEDs allows for proper compensation to the two white LEDs to occur.

Calculating the appropriate mixing combination for each LED will vary at each brightness level because traditional lighting sources will have different lighting effect at each brightness level. For example, when a halogen lamp gets dimmed, the color usually takes on a more pronounced orange or red hue. By testing the LEDs for the variance within the different LEDs that are placed in the lighting housing and calibrating the controller to account for these differences, an evenly blended white color throughout the lighting lens can be achieved. Such a method can be done for all different types of LEDs, including an RGB. RGBA and RGBW LED solution. Doing such a calibration and preprogramming of the controller allows for the inclusion of different types of LEDs, varying in quality and price, into the lighting fixture while still maintaining the evenness of the color blend. Once the controller has been programmed, the invented lighting fixture can be used with many different mixing systems that exist in the marketplace.

What is claimed is:

1. An LED lighting device, comprising:
a housing;
a group of LEDs located in said housing; wherein said group of LEDs are situated in said housing to allow for an even blending of light that is emitted by each LED of said group wherein said group of LEDs are comprised of two white LEDs and a first colored LED.

2. The LED lighting device as recited in claim 1, wherein said white LEDs are comprised of a warm white and cool white LEDs.

3. The LED lighting device as recited in claim 1, further comprising a lens cap above said group of LEDs wherein said even blending of light will occur on the surface of said lens cap.

4. The LED lighting device as recited in claim 3, further comprising a diffusion gel located with said lens cap.

5. The LED lighting device as recited in claim 3, further comprising a holographic paper located along with said lens cap.

6. The LED lighting device as recited in claim 1, wherein said first colored LED is an amber LED.

7. The LED lighting device as recited in claim 1, wherein said first colored LED is a red LED.

8. The LED lighting device as recited in claim 1, wherein said group of LEDs further comprises of second colored LED.

9. The LED lighting device as recited in claim 8, wherein said first and second LED are an amber and red LED.

10. The LED lighting device as recited in claim 1, wherein said group is situated in said housing such that said colored LED is located in between said two white LEDs.

11. The LED lighting device as recited in claim 1, further comprising a remote controller that allows a user to select a preset lighting effect that will be effected by said lighting device.

12. The LED lighting device as recited in claim 1, further comprising a controller that will control the mixture of light from said group of LEDs.

13. The LED lighting device as recited in claim 12 wherein said controller is programmed to account for variations of light from different LEDs when determining the correct mixture of light from said group of LEDs.

14. The LED lighting device as recited in claim 13 wherein said controller is capable of receiving initial values pertaining to said group of LEDs; the initial values representing measured characteristics of said group of LEDs and are used by said controller in determining the correct mixture of light from said group of LEDs.

15. The LED lighting device as recited in claim 11, wherein said preset lighting effect is a type of traditional lighting source.

16. An LED lighting device, comprising:
a housing that is capable of holding a plurality of LEDs;
a plurality of LEDs located in said housing such that the light from each LED will be evenly blended with the light each other LED in said plurality; said plurality of LEDs comprised of a warm white LED, a cool white LED and a colored LED.

17. The LED lighting device a recited in claim 16, wherein said colored LED is an amber LED.

18. The LED lighting device a recited in claim 16, wherein said colored LED is a red LED.

19. The LED lighting device a recited in claim 16 wherein said plurality of LEDs further comprises a second colored LED.

20. An LED lighting device, comprising:
a housing capable of housing LEDs;
a plurality of LEDs that are situated in groups such that the light from the plurality of LEDs will be evenly blended in with the light from the other LEDs in the group and wherein the plurality of LEDs are comprised of a colored LED and two white LEDs.

21. An LED lighting device, comprising:
a housing capable of housing a group of LEDs;
a controller connected to said group of LEDs; said controller comprising of a processor and memory; said processor capable of running computer software;
computer software running on said processor; wherein said computer software is capable of setting the appropriate levels of brightness of each LED is said group of LEDs wherein the levels of brightness are chosen to effect a certain color temperature and takes into account the starting values of the group of LEDs.

22. The LED lighting device as recited in claim 21, wherein the starting values of the group of LEDs comprises of the color temperature.

23. The LED lighting device as recited in claim 21, wherein the starting values of the group of LEDs comprises of the g-value.

24. The LED lighting device as recited in claim 21, wherein the starting values of the group of LEDs comprises of the r-value.

25. The LED lighting device as recited in claim 21, wherein the group of LEDs comprises of two white LEDs and one colored LED.
